(19) United States
(12) Patent Application Publication
(10) Pub. No.: US 2018/0122541 A1
(43) Pub. Date: May 3, 2018

(54) FE-BASED AMORPHOUS SOFT MAGNETIC BULK ALLOY METHOD FOR FABRICATING THE SAME AND APPLICATIONS THEREOF

(71) Applicant: INDUSTRIAL TECHNOLOGY RESEARCH INSTITUTE, Hsinchu (TW)

(72) Inventors: Li-Shing CHOU, Tainan City (TW); Yen-Yu HOU, Tainan City (TW); Chih-Chao YANG, Tainan City (TW)

(73) Assignee: INDUSTRIAL TECHNOLOGY RESEARCH INSTITUTE, Hsinchu (TW)

(21) Appl. No.: 15/391,316

(22) Filed: Dec. 27, 2016

(30) Foreign Application Priority Data
Nov. 2, 2016 (TW) 105135574

(51) Int. Cl. H01F 1/147; H01F 41/02; H02K 1/02; H02K 1/27; C22C 38/10; C22C 38/02; C22C 38/00; B22F 3/105; B22F 3/24; B22F 9/08; B23K 26/342; B23K 26/70; C21D 1/26; B33Y 10/00; B33Y 40/00; B33Y 70/00; B33Y 80/00

(52) U.S. Cl. CPC H01F 1/14766; B23K 2203/02; H02K 1/02; H02K 1/27; C22C 38/10; C22C 38/02; C22C 38/002; B22F 3/1055; B22F 3/24; B22F 9/082; B23K 26/342; B23K 26/70; C21D 1/26; B33Y 10/00; B33Y 40/00; B33Y 70/00; B33Y 80/00; B22F 2003/248; B22F 2009/0848; B22F 2009/086; B22F 2998/10; B22F 2301/35; B22F 2303/01; H01F 41/0206

(57) ABSTRACT

A Fe-based amorphous soft magnetic bulk alloy has a three dimensional structure which includes a Fe-based amorphous soft magnetic component consisting of Feₐ Co_{b} P_{c} B_{d} Siₑ, wherein a, b, c d and e is the atomic percentage (at %) of each component to meet 76≤a≤80, 1≤b≤4, 9≤c≤11, 3≤d≤5 and 5≤e≤7.

This application claims the benefit of Taiwan application Serial No. 105135574, filed, Nov. 2, 2016, the subject matter of which is incorporated herein by reference.

### TECHNICAL FIELD

The technical field relates to a metallic soft magnetic material with a high magnetic flux density and permeability, the method for fabricating the same and applications thereof; and more particularly to a Fe-based amorphous soft magnetic bulk alloy, the method for fabricating the same and applications thereof.

### BACKGROUND

Material used for making an iron-core of a magnetic motor device should have a high magnetic flux density and permeability. Silicon steel is a traditional material used for making an iron-core of a magnetic motor device. However, the iron-core of a magnetic motor device may be only suitable for low frequency directive current (DC)/Low-frequency alternating current (AC) operations due to its low resistivity. As a magnetic motor device applying an iron-core is operated at low frequency current, eddy current loss can increase and create more and more unwanted power loss. In order to reduce eddy current loss and unwanted power loss of the magnetic motor device, a static iron core formed by alternatively stacking silicon steel and isolating layer has been provided for making a magnetic motor device. However, the process for fabricating the static iron core is rather complicated; the manufacturing cost thereof is higher than traditional once; and it is difficult to be scaled down due to its' complicate structure.

Fe-based amorphous soft magnetic material is characterized by advantages of high saturation magnetic fluxdensity, high resistivity and low coercivity (Hc), and has been applied to make an iron core of a magnetic motor device for the purpose of reducing eddy current loss and unwanted power loss of the magnetic motor device. However, Fe-based amorphous soft magnetic material is a hard brittle material difficult to be cut, finished and processed by machines. It is hard to be applied for making device having complicated structure to satisfy the current design requirements in the magnetic motor device. The traditional processing method of a Fe-based amorphous soft magnetic material is general based on tap casting technology which has processing limits on the size. In addition, the applications of the Fe-based amorphous soft magnetic material may be rather limited due to its high material loss and low coil space factor.

Therefore, there is a need of providing a Fe-based amorphous soft magnetic bulk alloy, the method for fabricating the same and applications thereof.

### SUMMARY

One aspect of the present disclosure, a Fe-based amorphous soft magnetic bulk alloy is provided. The Fe-based amorphous soft magnetic bulk alloy has a three dimensional (3D) structure which includes a Fe-based amorphous soft magnetic component consisting of Feₐ Co_{b} P_{c} B_{d} Siₑ, wherein a, b, c d and e is the atomic percentage (at %) of each component to meet 76≤a≤80, 1≤b≤4, 9≤c≤11, 3≤d≤5 and 5≤e≤7.

Another aspect of the present disclosure, a method for fabricating a Fe-based amorphous soft magnetic bulk alloy is provided is provided, wherein the method includes steps as follows: The Fe-based amorphous soft magnetic component aforementioned is provided. An atomization process is then performed to divide the Fe-based amorphous soft magnetic component into a plurality of particles. Next, the particles are sintered or melted to form a 3D structure. Subsequently, the 3D structure is subjected to a thermal annealing process.

In accordance with the embodiments of the present disclosure, a Fe-based amorphous soft magnetic bulk alloy and the method for fabricating the same are provided. A plurality of Fe-based amorphous soft magnetic particles with high roundness are prepared by an atomization process. The Fe-based amorphous soft magnetic particles are then sintered or melted to form a Fe-based amorphous soft magnetic bulk alloy with a 3D structure, whereby the working properties of the Fe-based amorphous soft magnetic component can be improved significantly by increasing the thickness thereof to form a bulk structure, whereby the scope of the applications of the Fe-based amorphous soft magnetic component can be broaden. When the Fe-based amorphous soft magnetic bulk alloy is adopted to make an iron core of a magnetic motor device, the magnetic flux (℠=Bs) and resistance of the magnetic iron core can be increased, meanwhile to reduce the Hc of the magnetic iron core and the eddy current loss of the magnetic motor device.

### BRIEF DESCRIPTION OF THE DRAWINGS

The above and other aspects of the disclosure will become better understood with regard to the following detailed description of the preferred but non-limiting embodiment(s). The following description is made with reference to the accompanying drawings

FIG. 1 is a process flow diagram illustrating the method for fabricating a Fe-based amorphous soft magnetic bulk alloy according to one embodiment of the present disclosure;

FIG. 2A is a schematic diagram illustrating an apparatus used to perform an atomization process;

FIG. 2B is a scanning electron microscope (SEM) image illustrating the Fe-based amorphous soft magnetic particles prepared by the process as set forth in the step S2 of FIG. 1; and

FIG. 3 is a cross-sectional view illustrating a 3D structure formed by the process as set forth in the step S3 of FIG. 1;

FIG. 4 is a cross-sectional view illustrating a magnetic motor device having an iron core adopting the Fe-based amorphous soft magnetic bulk alloy according to one embodiment of the present disclosure.

### DETAILED DESCRIPTION

According to the present disclosure, a Fe-based amorphous soft magnetic bulk alloy, the method for fabricating the same and the applications thereof are provided to solve the problems of eddy current loss occurs in a traditional magnetic motor device and the poor working properties of Fe-based amorphous soft magnetic material. A number of embodiments of the present disclosure are disclosed below with reference to accompanying drawings.

However, the structure and content disclosed in the embodiments are for exemplary and explanatory purposes only, and the scope of protection of the present disclosure is not limited to the embodiments. Designations common to the accompanying drawings and embodiments are used to indicate identical or similar elements. It should be noted that the present disclosure does not illustrate all possible embodiments, and anyone skilled in the technology field of the invention will be able to make suitable modifications or changes based on the specification disclosed below to meet actual needs without breaching the spirit of the invention. The present disclosure is applicable to other implementations not disclosed in the specification. In addition, the drawings are simplified such that the content of the embodiments can be clearly described, and the shapes, sizes and scales of elements are schematically shown in the drawings for explanatory and exemplary purposes only, not for limiting the scope of protection of the present disclosure.

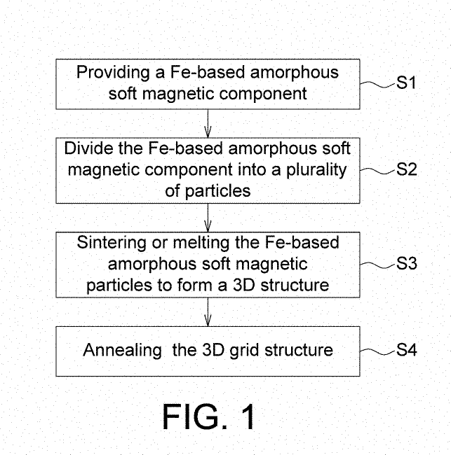

FIG. 1 is a process flow diagram illustrating the method for fabricating a Fe-based amorphous soft magnetic bulk alloy 100 according to one embodiment of the present disclosure. The method for fabricating the Fe-based amorphous soft magnetic bulk alloy 100 includes steps as follows: Firstly a Fe-based amorphous soft magnetic component is provided (see the step S1 depicted in FIG. 1), wherein the Fe-based amorphous soft magnetic component consists of Feₐ Co_{b} P_{c} B_{d} Siₑ, wherein a, b, c d and e is the at % of each component to meet 76≤a≤80, 1≤b≤4, 9≤c≤11, 3≤d≤5 and 5≤e≤7. However, the at % of each component iron (Fe), cobalt (Co), phosphorus (P), boron (B) or silicon (Si) may not be limited to this regards. In some embodiments of the present disclosure, the at % of each component to may meet 76≤a≤78, 2≤b≤4, 9≤c≤11, 3≤d≤5 and 5≤e≤7.

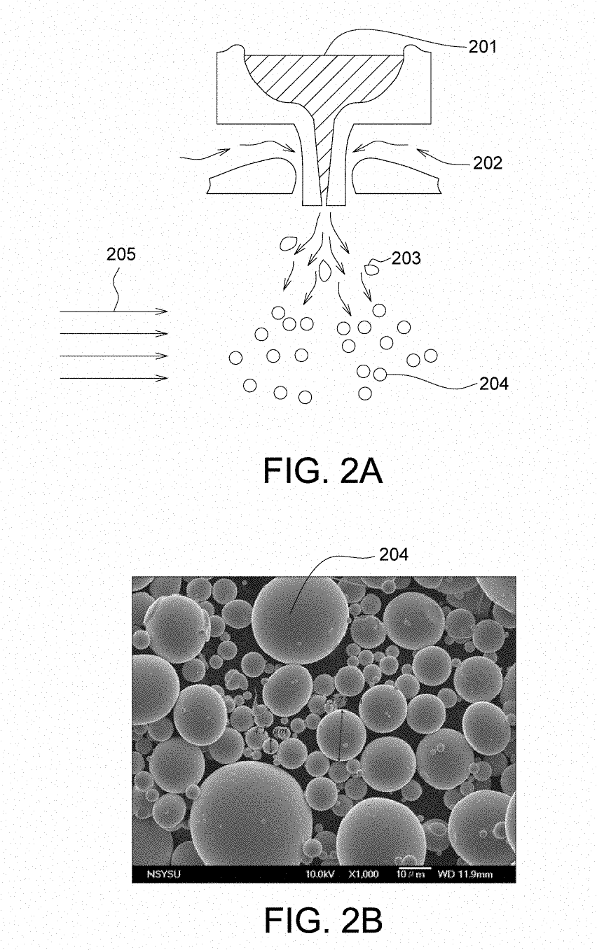

An atomization process is then performed to divide the Fe-based amorphous soft magnetic component into a plurality of particles 204 (see the step S2 depicted in FIG. 1). Regarding to FIG. 2A, FIG. 2A is a schematic diagram illustrating an apparatus used to perform an atomization process. The atomization process includes steps as follows: The Fe-based amorphous soft magnetic component is firstly subjected to a melting process to form a molten solution 201. Next, the molten solution 201 is broken into a plurality of droplets 203 by a fluid 202, such as water or air, and droplets 203 are then cool down to form a plurality of particles 204.

FIG. 2B is a SEM image illustrating the Fe-based amorphous soft magnetic particles 204 prepared by the process as set forth in the step S2 of FIG. 1. In some embodiments of the present disclosure, the Fe-based amorphous soft magnetic particles 204 have an average particle size ranging from 25 micrometers (μm) to 70 μm. In addition, it can be observed in the SEM image that each of the Fe-based amorphous soft magnetic particles 204 has a high roundness. In the present embodiment, the Fe-based amorphous soft magnetic particles 204 have an average particle size about 35 μm.

In some embodiments of the present disclosure, the atomization process can be selected from a group consisting of water atomization process, airstream atomization process, centrifugal atomization process and ultrasonic inter-gas atomization. In the present embodiment, a pure argon (Ar) flow 202 is applied to break the molten solution 201 into a plurality of droplets 203. The droplets 203 may then fall down under the force of gravity to pass through an inter-gas flow 205, whereby the falling droplets 203 are cooled down and solidified to form a plurality of solid particles 204.

A plurality of embodiments of the Fe-based amorphous soft magnetic particles 204 with different at % that are prepared by the method of the present disclosure and the magnetic flux (Bs) as well as the coercivity (Hc) thereof are listed in Table 1:

TABLE 1

| Embodiments | 1 | 2 | 3 | 4 | 5 |
|---|---|---|---|---|---|
| magnetic | Fe₈₀P₁₀B₄Si₆ | Fe₇₉Co₁P₁₀B₄Si₆ | Fe₇₈Co₂P₁₀B₄Si₆ | Fe₇₇Co₃P₁₀B₄Si₆ | Fe₇₆Co₄P₁₀B₄Si₆ |
| particles | | | | | |
| Bs (T) | 1.35 | 1.46 | 1.55 | 1.62 | 1.30 |
| Hc (A/m) | 20.4 | 15.5 | 10.6 | 6.2 | 8.2 |

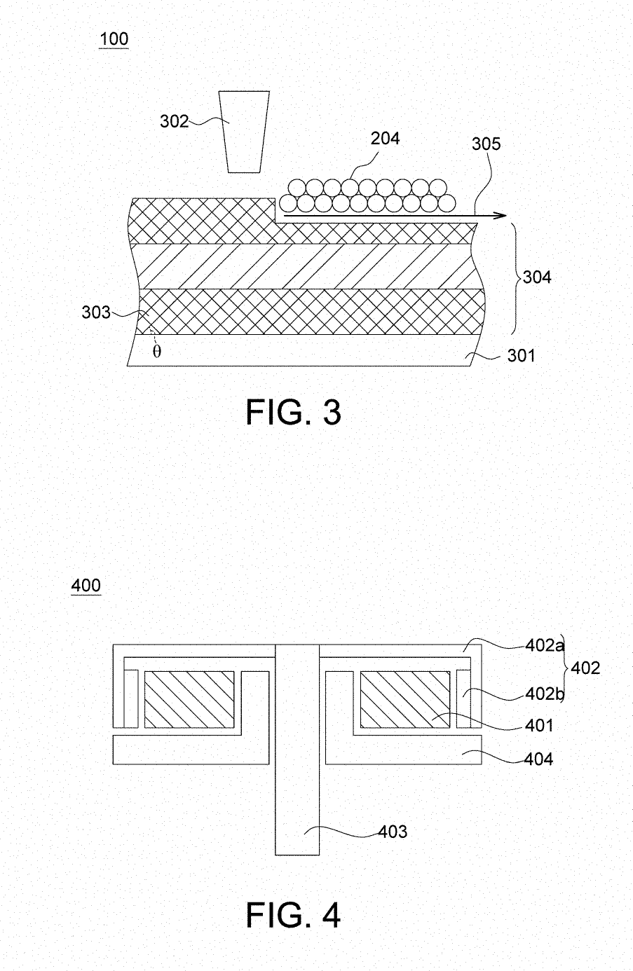

Next, the Fe-based amorphous soft magnetic particles 204 are sintered or melted to form a 3D structure (see the step S3 depicted in FIG. 1). Subsequently, the 3D structure is subjected to a thermal annealing process. FIG. 3 is a cross-sectional view illustrating a 3D structure formed by the process as set forth in the step S3 of FIG. 1. The process for forming the 3D structure includes following steps: The Fe-based amorphous soft magnetic particles 204 are firstly disposed to cover a surface 301a of a substrate 301. A focused beam of energy 302 is then directed to the surface 301a of the substrate 301 along a predetermined laser scanning path 305 for sintering or melting the Fe-based amorphous soft magnetic particles 204, whereby a plurality of bumpings 303 are formed on the surface 301a of the substrate 301; each of the bumpings 303 can form a non-straight angle θ with the surface 301a of the substrate 301; and the bumpings 303 can be assembled to define a grid structure 304 on the surface 301a of the substrate 301.

In some embodiments of the present disclosure, the substrate 301 can be a flexible or rigid metal sheet. The focused beam of energy 302 can be a laser beam. In the present embodiment, a laser beam with an average output power ranging from 200 W to 340 W, a scanning speed ranging from 1500 millimeters/second (mm/s) to 4500 mm/s is directed to the surface 301a of the substrate 301 for sintering or melting the Fe-based amorphous soft magnetic particles 204, so as to form the grid structure 304 on a metal substrate. The grid structure 304 can be a single-layer structure or a multi-layer structure having a thickness about 2 centimeters (cm).

Subsequently, the 3D grid structure 304 is subjected to a thermal annealing process (see the step S4 depicted in FIG. 1), meanwhile the process for fabricating the Fe-based amorphous soft magnetic bulk alloy 100 is implemented. In some embodiments of the present disclosure, the thermal annealing process is carried out in an air atmosphere with a treatment time ranging from 0.5 hours (hr) to 2 hr and an annealing temperature ranging from 300° C. to 600° C.

The Fe-based amorphous soft magnetic particles 204, the Fe-based amorphous soft magnetic bulk alloy 100 not only has a 3D dimension, but also has electromagnetic properties, such as magnetic flux (Bs), Hc and resistance different from that of the Fe-based amorphous soft magnetic particles 204. In some embodiments of the present disclosure, the Fe-based amorphous soft magnetic bulk alloy 100 may have a magnetic flux (Bs) ranging from 1.3 tesla (T) to 1.7 T, a Hc ranging from 8 A/m to 16 A/m and a resistance about 200 μΩ-cm.

A plurality of embodiments of the Fe-based amorphous soft magnetic bulk alloy 100 with different at % that are prepared by the method of the present disclosure and the magnetic flux (Bs), the coercivity (Hc) as well as the resistance thereof are listed in Table 2:

TABLE 2

| Embodiments | 1 | 2 | 3 | 4 | 5 |
|---|---|---|---|---|---|
| magnetic | Fe₈₀P₁₀B₄Si₆ | Fe₇₉Co₁P₁₀B₄Si₆ | Fe₇₈Co₂P₁₀B₄Si₆ | Fe₇₇Co₃P₁₀B₄Si₆ | Fe₇₆Co₄P₁₀B₄Si₆ |
| bulk alloy | | | | | |
| Bs (T) | 1.7 | 1.62 | 1.66 | 1.70 | 1.35 |
| Hc (Nm) | 17.5 | 10.5 | 5.25 | 2.2 | 7.5 |
| Resistance | 150 | 170 | 190 | 200 | 210 |
| (μ Ω-cm) | | | | | |

In comparison the Fe-based amorphous soft magnetic bulk alloy 100 (listed in Table 2) with the Fe-based amorphous soft magnetic particles 204 (listed in Table 1), it can be indicated that the Fe-based amorphous soft magnetic bulk alloy 100 and the Fe-based amorphous soft magnetic particles 204 have different magnetic fluxes (Bs), coercivities (Hc) and the resistances, nevertheless they are made of identical magnetic material, wherein the Fe-based amorphous soft magnetic bulk alloy 100 has a greater magnetic flux (Bs), a higher resistance and a lower coercivity than that of the Fe-based amorphous soft magnetic particles 204.

In these aforementioned embodiments, embodiment 4 (which includes Fe₇₇Co₃P₁₀B₄Si₆) has the most suitable electromagnetic properties (magnetic flux (Bs), coercivity (Hc) and resistance) for making an iron core of a magnetic motor device. FIG. 4 is a cross-sectional view illustrating a magnetic motor device 400 having an iron core adopting the Fe-based amorphous soft magnetic bulk alloy 100 according to one embodiment of the present disclosure. In the present embodiment, the magnetic motor device 400 can be an axial-flux motor device including a stator iron core 401, a rotor 402 and a rotation shaft 403. The stator iron core 401 is a disk-like structure configured by the Fe-based amorphous soft magnetic bulk alloy 100 and steadily fixed on a base 404. The rotor 402 including a disk-like iron cover 402a serving as a sheath of the stator iron core 401 and a magnet 402b disposed between the disk-like iron cover 402a and the stator iron core 401. The rotor 402 is connected to the rotation shaft 403 coaxially and rotatably assembled at the base 404 and passing through the stator iron core 401. When an external current coming from an external wire (not shown) passing through the stator coil (not shown) to form magnetic fields, the stator iron core 401 can serve as an electromagnet, and the rotation shaft 403 can be driven to coaxially rotate by a magnetic force generated between the stator iron core 401 and the magnet 402b.

To make a comparison between the stator iron core 401 that is configured by the Fe-based amorphous soft magnetic bulk alloy 100 with different comparison embodiments 1 and 2 (see Table 3), that are iron cores respectively configured by cold-rolled silicon steel and Fe-based amorphous soft magnetic thin cast strips, it can be indicated that the stator iron core 401 configured by the Fe-based amorphous soft magnetic bulk alloy 100 has a greater magnetic flux (Bs), a higher resistance and a lower coercivity than that of the iron cores respectively configured by cold-rolled silicon steel plates and Fe-based amorphous soft magnetic thin cast strips.

TABLE 3

| | comparison | comparison | |
|---|---|---|---|
| | embodiment 1 | embodiment 2 | Embodiment 4 |
| Material of | silicon steel | Fe-based | Fe₇₇Co₃P₁₀B₄Si₆ |
| the iron core | | amorphous soft | |
| | | magnetic material | |
| Structure | rolled plates | thin cast strips | bulk |
| | (thickness | (thickness < | (thickness > |
| | about 0.3 mm) | 30 μm) | 2 cm) |
| Bs (T) | 1.60 | 1.56 | 1.70 |
| Hc (A/m) | 45 | 2.4 | 2.2 |
| resistance | 50 | 120 | 200 |
| (μ Ω-cm) | | | |

In addition, since the Fe-based amorphous soft magnetic bulk alloy 100 has a 3D grid structure 304 with a thickness greater than 2 cm, thus it has greater fracture toughness and mechanical stress resistance than the Fe-based amorphous soft magnetic thin cast strips. In other words, the Fe-based amorphous soft magnetic bulk alloy 100 may have better working properties suitable for manufacturing device with more complicated structure, whereby the scope of the applications of the Fe-based amorphous soft magnetic component can be broaden. In one embodiment of the present disclosure, the Fe-based amorphous soft magnetic bulk alloy 100 may have a hardness about 950 Hv and a tensile strength about 2800 MPa.

In accordance with the embodiments of the present disclosure, a Fe-based amorphous soft magnetic bulk alloy and the method for fabricating the same are provided. A plurality of Fe-based amorphous soft magnetic particles with high roundness are prepared by an atomization process. The Fe-based amorphous soft magnetic particles are then sintered or melted to form a Fe-based amorphous soft magnetic bulk alloy with a 3D structure, whereby the working properties of the Fe-based amorphous soft magnetic component can be improved significantly by increasing the thickness thereof to form a bulk structure, whereby the scope of the applications of the Fe-based amorphous soft magnetic component can be broaden. When the Fe-based amorphous soft magnetic bulk alloy is adopted to make an iron core of a magnetic motor device, the magnetic flux (ϕ=Bs) and resistance of the magnetic iron core can be increased, meanwhile to reduce the Hc of the magnetic iron core and the eddy current loss of the magnetic motor device.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A Fe-based amorphous soft magnetic bulk alloy having a three dimensional (3D) structure comprising a Fe-based amorphous soft magnetic component consisting of Feₐ Co_{b} P_{c} B_{d} Siₑ, wherein a, b, c d and e is the atomic percentage (at %) of each component to meet 76≤a≤80, 1≤b≤4, 9≤c≤11, 3≤d≤5 and 5≤e≤7.

2. The Fe-based amorphous soft magnetic bulk alloy according to claim 1, wherein a, b, c d and e is the atomic percentage (at %) of each component to meet 76≤a≤78, 2≤b≤4, 9≤c≤11, 3≤d≤5 and 5≤e≤7.

3. The Fe-based amorphous soft magnetic bulk alloy according to claim 1, wherein the 3D structure is a grid structure.

4. The Fe-based amorphous soft magnetic bulk alloy according to claim 1, wherein the 3D structure has a thickness about 2 centimeters (cm).

5. The Fe-based amorphous soft magnetic bulk alloy according to claim 1, wherein the 3D structure has a magnetic flux (Bs) ranging from 1.3 tesla (T) to 1.7 T, a coercivity (Hc) ranging from 8 A/m to 16 A/m and a resistance about 200 μΩ-cm.

6. A method for fabricating a Fe-based amorphous soft magnetic bulk alloy, comprising:
providing the Fe-based amorphous soft magnetic component according to claim 1;
performing an atomization process to divide the Fe-based amorphous soft magnetic component into a plurality of particles;
sintering or melting the particles are to form a 3D structure; and
performing a thermal annealing process to the 3D structure.

7. The method according to claim 6, wherein the atomization process comprises:
melting the Fe-based amorphous soft magnetic component to form a molten solution;
breaking the molten solution into a plurality of droplets by a fluid; and
cooling down the droplets to form a plurality of the particles.

8. The method according to claim 6, wherein the process for forming the 3D structure comprising:
disposing the particles to cover a surface of a substrate;
directing a focused beam of energy to the surface of the substrate along a predetermined laser scanning path for sintering or melting the particles 204, so as to form a plurality of bumpings on the surface of the substrate, wherein each of the bumpings forms a non-straight angle with the surface of the substrate, and the bumpings is assembled to define a grid structure.

9. The method according to claim 8, wherein the focused beam of energy is a laser beam having an average output power ranging from 200 W to 340 W and a scanning speed ranging from 1500 millimeters/second (mm/s) to 4500 mm/s.

10. The method according to claim 6, wherein the thermal annealing process is carried out in an air atmosphere with a treatment time ranging from 0.5 hours (hr) to 2 hr and an annealing temperature ranging from 300° C. to 600° C.

11. A magnetic motor device, comprising:
a stator, comprising an iron core made of the Fe-based amorphous soft magnetic bulk alloy according to claim 1;
a rotation shaft, passing through the iron core; and
a rotor comprising a magnet and connected to the rotation shaft;
wherein the rotation shaft is driven to coaxially rotate by a magnetic force generated between the iron core and the magnet.
